(19) United States
(12) Patent Application Publication
(10) Pub. No.: US 2022/0090512 A1
(43) Pub. Date: Mar. 24, 2022

(54) TURBOMACHINE

(71) Applicant: GE Avio Srl, Turin (IT)

(72) Inventors: Roberto Maddaleno, Lanzo Torinese (IT); Andrea Depalma, Rivalta di Torino (IT)

(21) Appl. No.: 17/458,871

(22) Filed: Aug. 27, 2021

(30) Foreign Application Priority Data
Sep. 18, 2020 (IT) 102020000022084

(51) Int. Cl. F01D 15/12; F01D 25/16

(52) U.S. Cl. CPC F01D 15/12; F01D 25/16; F05D 2240/24; F05D 2240/52; F05D 2220/32

(57) ABSTRACT

A turbomachine defining a radial direction and an axial direction, the turbomachine including: a structural assembly comprising a frame and a static structure; a gearbox coupled to the structural assembly through the static structure; a turbine coupled to the gearbox and having a plurality of turbine rotor blades spaced apart from one another in the axial direction, each of the turbine rotor blades extending in the radial direction; and a thrust bearing disposed in a load path from the turbine to the static structure, the load path extending through the gearbox to transmit axial loads from the turbine to the static structure.

### GOVERNMENT CONTRACT

The project leading to this application has received funding from the Clean Sky 2 Joint Undertaking under the European Union's Horizon 2020 research and innovation program under grant agreement No. CS2-LPA-GAM-2018/2019-01.

### RELATED APPLICATION

The present application claims priority to Italian Patent Application Number 102020000022084, filed Sep. 18, 2020.

### FIELD

The present subject matter relates generally to a turbomachine, and more particularly, to a turbine of a turbomachine having interdigitated rotor blades coupled to a gearbox.

### BACKGROUND

Gas turbine engines generally include a turbine section downstream of a combustion section that is rotatable with a compressor section to rotate and operate the gas turbine engine to generate power, such as propulsive thrust. General gas turbine engine design criteria often include conflicting criteria that must be balanced or compromised, including increasing fuel efficiency, operational efficiency, and/or power output while maintaining or reducing weight, part count, and/or packaging (i.e. axial and/or radial dimensions of the engine).

Within at least certain gas turbine engines, the turbine section may include interdigitated rotors (i.e., successive rows or stages of rotating airfoils or blades). For example, a turbine section may include a turbine having a first plurality of low speed turbine rotor blades and a second plurality of high speed turbine rotor blades. The first plurality of low speed turbine rotor blades may be interdigitated with the second plurality of high speed turbine rotor blades. Such a configuration may result in a more efficient turbine.

However, problems may arise with how to support the first and/or second pluralities of rotor blades. Accordingly, an improved turbine would be useful.

### BRIEF DESCRIPTION

Aspects and advantages of the invention will be set forth in part in the following description, or may be obvious from the description, or may be learned through practice of the invention.

In one exemplary aspect of the present disclosure, a turbomachine defining a radial direction and an axial direction comprises a structural assembly comprising a frame and a static structure; a gearbox coupled to the structural assembly through the static structure; a turbine coupled to the gearbox and having a plurality of turbine rotor blades spaced apart from one another in the axial direction, each of the turbine rotor blades extending in the radial direction; and a thrust bearing disposed in a load path from the turbine to the static structure, the load path extending through the gearbox to transmit axial loads from the turbine to the static structure.

In another exemplary aspect of the present disclosure, a turbine section for a turbomachine defining an axial direction and a radial direction comprises a gearbox; a turbine coupled to the gearbox and having a plurality of turbine rotor blades spaced apart from one another in the axial direction, each of the turbine rotor blades extending in the radial direction; and a thrust bearing configured to be disposed in a load path from the turbine to a static structure of the turbomachine, the load path extending through the gearbox to transmit axial loads from the turbine to the static structure.

In another exemplary aspect of the present disclosure, a vaneless counter-rotating turbine (VCRT) turbomachine defining a radial direction and an axial direction comprises a gearbox coupled to a static structure of the turbomachine; a turbine coupled to the gearbox, the turbine comprising: a low-speed turbine including a first plurality of turbine rotor blades spaced apart from one another in the axial direction and extending radially from a rotatable drum; and a high-speed turbine including a second plurality of turbine rotor blades spaced apart from one another in the axial direction and extending radially from a rotatable drum, wherein each turbine rotor blade of the second plurality of turbine rotor blades is spaced apart in the axial direction by at least one turbine rotor blade of the first plurality or turbine rotor blades; and a thrust bearing disposed between the static structure and the drum of the high-speed turbine, the thrust bearing being configured to transmit axial loads from the high-speed turbine to the static structure.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 is a schematic cross-sectional view of an exemplary gas turbine engine incorporating an exemplary embodiment of a turbine section according to an exemplary embodiment of the present disclosure.

FIG. 2 is a close-up, schematic, cross-sectional view of a turbine section in accordance with an exemplary embodiment of the present disclosure.

FIG. 3 is a close-up, schematic, cross-sectional view of a turbine section in accordance with another exemplary embodiment of the present disclosure.

FIG. 4 is a close-up, schematic, cross-sectional view of a turbine section in accordance with another exemplary embodiment of the present disclosure.

FIG. 5 is a close-up, schematic, cross-sectional view of a turbine section in accordance with another exemplary embodiment of the present disclosure.

FIG. 6 is a close-up, schematic, cross-sectional view of a turbine section in accordance with another exemplary embodiment of the present disclosure.

FIG. 7 is a close-up, schematic, cross-sectional view of a turbine section in accordance with another exemplary embodiment of the present disclosure.

FIG. 8 is a close-up, schematic, cross-sectional view of a turbine section in accordance with another exemplary embodiment of the present disclosure.

FIG. 9 is a close-up, schematic, cross-sectional view of a turbine section in accordance with another exemplary embodiment of the present disclosure.

FIG. 10 is a close-up, schematic, cross-sectional view of a turbine section in accordance with another exemplary embodiment of the present disclosure

FIG. 11 is a close-up, schematic cross-sectional view of a turbine section in accordance with another exemplary aspect of the present disclosure.

FIG. 12 is a close-up, schematic, cross-sectional view of a turbine section in accordance with another exemplary embodiment of the present disclosure.

FIG. 13 is a close-up, schematic, cross-sectional view of a turbine section in accordance with another exemplary embodiment of the present disclosure.

FIG. 14 is a close-up, schematic, cross-sectional view of a turbine section in accordance with another exemplary embodiment of the present disclosure.

FIG. 15 is a close-up, schematic, cross-sectional view of a turbine section in accordance with another exemplary embodiment of the present disclosure.

FIG. 16 is a close-up, schematic, cross-sectional view of a turbine section in accordance with another exemplary embodiment of the present disclosure.

FIG. 17 is a close-up, schematic, cross-sectional view of a turbine section in accordance with another exemplary embodiment of the present disclosure.

FIG. 18 is a close-up, schematic, cross-sectional view of a turbine section in accordance with another exemplary embodiment of the present disclosure.

FIG. 19 is a close-up, schematic, cross-sectional view of a turbine section in accordance with another exemplary embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, affixing, or attaching, as well as indirect coupling, affixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In accordance with one or more embodiments described herein, a turbomachine can generally include a gearbox coupled with a structural assembly of the turbomachine, a turbine coupled to the gearbox, and a thrust bearing disposed in a load path from the turbine to the static structure, the load path extending through the gearbox to transmit axial loads from the turbine to the static structure. The thrust bearing can be disposed in the load path at a location upstream of the gearbox, for example, within a circumferentially extending cavity of the static structure. The thrust bearing can provide enhanced integration between the turbine and the gearbox. Embodiments described herein may be used on traditional multi-stage turbine systems, including for example, discrete, turbine sections or in a turbine structure comprising a first plurality of turbine rotor blades and a second plurality of turbine rotor blades at least partially interdigitated with the first plurality of turbine rotor blades.

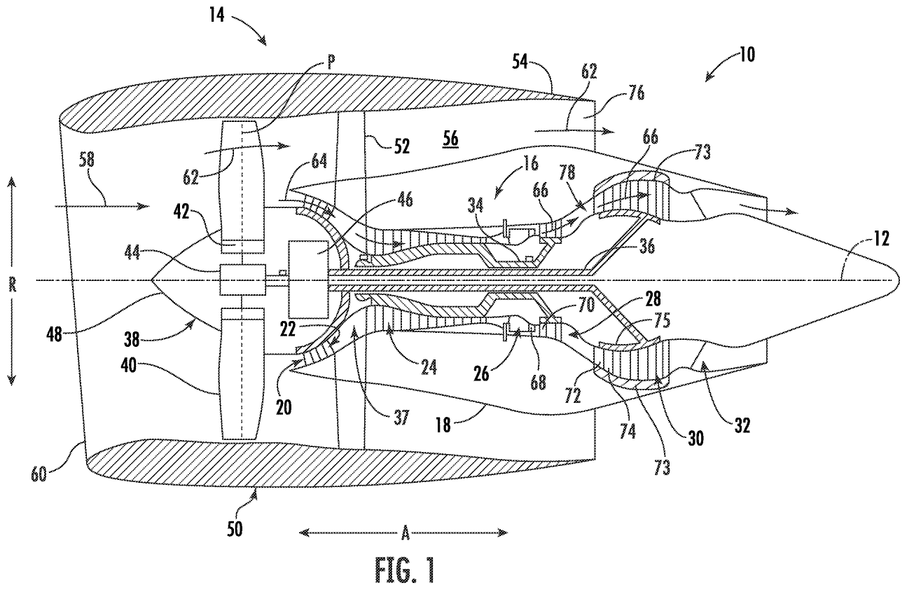

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (i.e., a direction extending about the axial direction A; not depicted). In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. The compressor section, combustion section 26, and turbine section together define a core air flowpath 37 extending from the annular inlet 20 through the LP compressor 22, HP compressor 24, combustion section 26, HP turbine section 28, LP turbine section 30 and jet nozzle exhaust section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the embodiment depicted, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40, e.g., in unison. The fan blades 40, disk 42, and actuation member 44 are together rotatable about the longitudinal axis 12 by LP shaft 36 across a power gear box 46. The power gear box 46 includes a plurality of gears for stepping down the rotational speed of the LP shaft 36 to a more efficient rotational fan speed.

Referring still to the exemplary embodiment of FIG. 1, the disk 42 is covered by rotatable front spinner cone 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that for the embodiment depicted, the nacelle 50 is supported relative to the core turbine engine 16 by a plurality of circumferentially-spaced outlet guide vanes 52. Moreover, a downstream section 54 of the nacelle 50 extends over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to an inner casing (not shown) and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of a first plurality of LP turbine rotor blades 72 that are coupled to an outer drum 73, and a second plurality of LP turbine rotor blades 74 that are coupled to an inner drum 75. The first plurality of LP turbine rotor blades 72 and second plurality of LP turbine rotor blades 74 are alternatingly spaced and rotatable with one another through a gearbox (not shown) to together drive the LP shaft or spool 36, thus causing the LP shaft or spool 36 to rotate. Such thereby supports operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated, however, that the exemplary turbofan engine 10 depicted in FIG. 1 is by way of example only, and that in other exemplary embodiments, the turbofan engine 10 may have any other suitable configuration. For example, in other exemplary embodiments, the turbine fan engine 10 may instead be configured as any other suitable turbomachine including, e.g., any other suitable number of shafts or spools, and excluding, e.g., the power gearbox 46 and/or fan 38, etc. Accordingly, it will be appreciated that in other exemplary embodiments, the turbofan engine 10 may instead be configured as, e.g., a turbojet engine, a turboshaft engine, a turboprop engine, etc., and further may be configured as an aeroderivative gas turbine engine or industrial gas turbine engine.

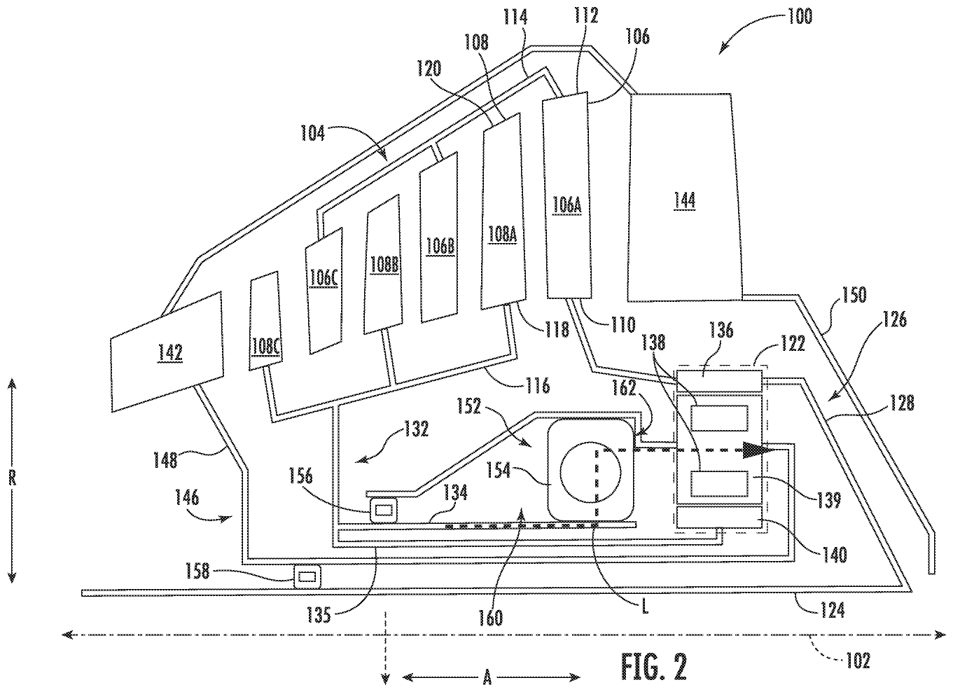

Referring now to FIG. 2, a schematic, side, cross-sectional view is provided of a turbine section 100 of a turbomachine in accordance with an exemplary embodiment of the present disclosure. The exemplary turbine section 100 depicted in FIG. 2 may be incorporated into, e.g., the exemplary turbofan engine 10 described above with reference to FIG. 1. However, in other exemplary embodiments, the turbine section 100 may be integrated into any other suitable machine utilizing a turbine.

Accordingly, it will be appreciated that the turbomachine generally defines a radial direction R, an axial direction A, and a longitudinal centerline 102. Further, the turbine section 100 includes a turbine 104, with the turbine 104 of the turbine section 100 being rotatable about the axial direction A (i.e., includes one or more components rotatable about the axial direction A). For example, in certain embodiments, the turbine 104 may be a low pressure turbine (such as the exemplary low pressure turbine 30 of FIG. 1), or alternatively may be any other turbine (such as, a high pressure turbine, an intermediate turbine, a dual-use turbine functioning as part of a high pressure turbine and/or a low pressure turbine, etc.).

Moreover, for the exemplary embodiment depicted, the turbine 104 includes a plurality of turbine rotor blades spaced along the axial direction A. More specifically, for the exemplary embodiment depicted, the turbine 104 includes a first plurality of turbine rotor blades 106 and a second plurality of turbine rotor blades 108. In an embodiment, the first plurality of turbine rotor blades 106 can correspond with a low-speed turbine assembly and the second plurality of turbine rotor blades 108 can correspond with a high-speed turbine assembly, where low- and high-speeds are defined relative to one another. As will be discussed in greater detail below, the first plurality of turbine rotor blades 106 and second plurality of turbine rotor blades 108 are alternatingly spaced, e.g., interdigitated, along the axial direction A.

Referring initially to the first plurality of turbine rotor blades 106, each of the first plurality of turbine rotor blades 106 extends generally along the radial direction R between a radially inner end 110 and a radially outer end 112. Additionally, the first plurality of turbine rotor blades 106 includes a first turbine rotor blade 106A, a second turbine rotor blade 106B, and a third turbine rotor blade 106C, each spaced apart from one another along the axial direction A. Further, the first plurality of turbine rotor blades 106 are coupled through a split drum configuration. For example, the radially outer end 112 of the first turbine rotor blade 106A is mechanically coupled to the radially outer ends 112 of the second turbine rotor blade 106B and the third turbine rotor blade 106C. More specifically, for the embodiment depicted, the first turbine rotor blade 106A, second turbine rotor blade 106B, and third turbine rotor blade 106C of the first plurality of turbine rotor blades 106 are mechanically coupled through an outer drum 114. Notably, for the embodiment depicted, the first turbine rotor blade 106A, the second turbine rotor blade 106B, and the third turbine rotor blade 106C of the first plurality of turbine rotor blades 106 are each spaced sequentially along the axial direction A.

Referring now to the second plurality of turbine rotor blades 108, the second plurality of turbine rotor blades 108 generally includes a first turbine rotor blade 108A, a second turbine rotor blade 108B, and a third turbine rotor blade 108C, each of which extends generally along the radial direction R between a radially inner end 118 and a radially outer end 120. Further, the second plurality of turbine rotor blades 108 are, for the embodiment depicted, similarly attached using a split drum configuration. For example, the radially inner end 118 of the first turbine rotor blade 108A is mechanically coupled to the radially inner ends 118 of the second turbine rotor blade 108B and the third turbine rotor blade 108C. More specifically, for the embodiment depicted, the first turbine rotor blade 108A, the second turbine rotor blade 108B, and the third turbine rotor blade 108C of the second plurality of turbine rotor blades 108 are mechanically coupled through an inner set of disks 116. It should be appreciated that as used herein, “coupled at the radially inner ends” and “coupled at the radially outer ends” refers generally to any direct or indirect coupling means or mechanism to connect the components. For example, the inner disk 116 is coupled to the second plurality of turbine rotor blades 108 through arms of the inner disk 116.

As previously stated, for the embodiment depicted, the first plurality of turbine rotor blades 106 and second plurality of turbine rotor blades 108 are alternatingly spaced along the axial direction A. More specifically, as used herein, the term “alternatingly spaced along the axial direction A” refers to the second plurality of turbine rotor blades 108 including at least one turbine rotor blade positioned along the axial direction A between two axially spaced turbine rotor blades of the first plurality of turbine rotor blades 106. For example, for the embodiment depicted, alternatingly spaced along the axial direction A refers to the second plurality of turbine rotor blades 108 including at least one turbine rotor blade positioned between the first and second turbine rotor blades 106A, 106B of the first plurality of turbine rotor blades 106 along the axial direction A, or between the second and third turbine rotor blades 106B, 106C of the first plurality of turbine rotor blades 106 along the axial direction A.

For the embodiment depicted, the turbomachine further includes a gearbox 122 and a spool 124, with the first plurality of turbine rotor blades 106 and the second plurality of turbine rotor blades 108 rotatable with one another through the gearbox 122. In at least certain exemplary embodiments, the spool 124 may be configured as, e.g., the exemplary low pressure spool 36 described above with reference to FIG. 1. It should be appreciated, however, that in other exemplary embodiments, the spool 124 may be any other spool (e.g., a high pressure spool, an intermediate spool, etc.), and further that the gearbox 122 may be any other suitable speed change device. For example, in other exemplary embodiments, the gearbox 122 may instead be a hydraulic torque converter, an electric machine, a transmission, etc.

Referring still to FIG. 2, the turbine section 100 includes a first support member assembly 126 having a first support member 128 and a second support member assembly 132 having a second support member 134. The first support member 128 couples the radially inner end 110 of the first turbine rotor blade 106A of the first plurality of turbine rotor blades 106 to the spool 124, and further couples the first plurality of turbine rotor blades 106 to the gearbox 122. The second support member 134 couples the second plurality of turbine rotor blades 108, or rather the radially inner end 118 of the second plurality of turbine rotor blades 108, to the gearbox 122. Notably, however, in other exemplary embodiments, the first support member 128 may couple to any of the other turbine rotor blades within the first plurality of turbine rotor blades 106 at a radially inner end 110 (either directly or through, e.g., a rotor), and similarly, the second support member 134 may couple to any of the other turbine rotor blades of the second plurality of turbine rotor blades 108 at the radially inner ends 118 (either directly or through, e.g., the rotors). The second support member 134 may be configured to transmit radial and axial forces of the turbine rotor blades 108 as described in greater detail hereinafter, while a sun shaft 135 of the second support member assembly 132 transmits torque from the turbine rotor blades 108 to the gearbox 122. In certain instances, the sun shaft 135 does not support, or substantially does not support, axial or radial loading forces from the turbine rotor blades 108. That is, axial and radial loading forces can be transmitted through the second support member 134.

In a non-illustrated embodiment, the first support member assembly 126 includes a first flexible connection attached to the first support member 128 at a juncture of the first support member 128 (although, in other embodiments, the first flexible connection may be formed integrally with the first support member 128). Similarly, the second support member assembly 132 can include a second flexible connection attached to, or formed integrally with, the second support member 134. The first flexible connection and second flexible connection allow for a less rigid connection between the gearbox 122 and the first support member 128 and second support member 134, respectively. More particularly, the first flexible connection and the second flexible connection allow for a less rigid connection between the gearbox 122 and the first plurality of turbine rotor blades 106 and the second plurality of turbine rotor blades 108, respectively. In certain embodiments, the first flexible connection, the second flexible connection, or both, may be configured as members having bellows, splined connections with resilient material, etc.

In an embodiment, the gearbox 122 is configured as a planetary gear box including a ring gear 136, a plurality of planet gears 138 coupled to a planet gear carrier 139, and a sun gear 140. The first support member 128 is coupled to the ring gear 136 and the second support member 134 is coupled to the sun gear 140. Accordingly, the first plurality of turbine rotor blades 106 is coupled to the first gear, i.e., the ring gear 136, of the gearbox 122 through the first support member 128, and the second plurality of turbine rotor blades 108 is coupled to the second gear, i.e., the sun gear 140, of the gearbox 122 through the second support member 134. Additionally, the exemplary turbine section 100 further includes a turbine center frame 142, a turbine rear frame 144, and a static structure 146 including a center frame support assembly 148 coupled to the turbine center frame 142, and a rear frame support assembly 150 coupled to the turbine rear frame 144. As depicted in the illustrated embodiment, a portion of the static structure 146, and more particularly the center frame support assembly 148 can be cantilever mounted relative to the turbine center frame 142. The planet gear carrier 139 can be coupled to the turbine center frame 142 through the center frame support assembly 148 of the static structure 146.

In such a manner, it will be appreciated that for the embodiment depicted, the first plurality of turbine rotor blades 106 are configured to rotate in an opposite direction as compared to the second plurality of turbine rotor blades 108. For example, the first plurality of turbine rotor blades 106 may be configured to rotate in a first circumferential direction while the second plurality of turbine rotor blades 108 may be configured to rotate in a second circumferential direction opposite the first circumferential direction.

It should further be understood that the first circumferential direction and the second circumferential direction as used and described herein are intended to denote directions relative to one another. Therefore, the first circumferential direction may refer to a clockwise rotation (viewed from downstream looking upstream) and the second circumferential direction may refer to a counter-clockwise rotation (viewed from downstream looking upstream). Alternatively, the first circumferential direction may refer to a counter-clockwise rotation (viewed from downstream looking upstream) and the second circumferential direction may refer to a clockwise rotation (viewed from downstream looking upstream).

Moreover, it will be appreciated that for the embodiment depicted, the first plurality of turbine rotor blades 106 is configured as a plurality of low-speed turbine rotor blades, while the second plurality of turbine rotor blades 108 is configured as a plurality of high-speed turbine rotor blades. Such may be due to the gearing of the gearbox 122 and the fact that the first plurality of turbine rotor blades 106 are directly rotatable with the spool 124 (which may limit a rotational speed of the first plurality of turbine rotor blades 106). Regardless, it will be appreciated that for the embodiment depicted the plurality of low-speed turbine rotor blades and high-speed turbine rotor blades are alternatingly spaced as follows: a first high-speed turbine rotor blade (i.e., the first turbine rotor blade 108A of the second plurality of turbine rotor blades 108) is positioned between a first low-speed turbine rotor blade and a second low-speed turbine 104 blade (i.e., the first and second turbine rotor blades 106A, 106B of the first plurality of turbine rotor blades 106) along the axial direction A; a second high-speed turbine rotor blade (i.e., the second turbine rotor blade 108B of the second plurality of turbine rotor blades 108) is positioned behind a third low-speed turbine rotor blade (i.e., the third turbine rotor blade 106C of the first plurality of turbine rotor blades 106) along the axial direction A; and a third high-speed turbine rotor blade (i.e., the third turbine rotor blade 108C of the second plurality of turbine rotor blades 108) is positioned between the turbine center frame 142 and the first turbine rotor blades 106C of the first plurality of turbine rotor blades 106 along the axial direction, where the second turbine rotor blade 108B is positioned between the first low-speed turbine rotor blade and the third low-speed turbine rotor blade (i.e., the first and third turbine rotor blades 106A, 106C of the first plurality of turbine rotor blades 106) along the axial direction A.

Notably, it will be appreciated that for the embodiments described herein, the first turbine rotor blade 106A, second turbine rotor blade 106B, and third turbine rotor blade 106C of the first plurality of turbine rotor blades 106 generally represent a first stage of turbine rotor blades, a second stage of turbine rotor blades, and a third stage of turbine rotor blades, respectively. Similarly, the first turbine rotor blade 108A, second turbine rotor blade 108B, and third turbine rotor blade 108C of the second plurality of turbine rotor blades 108 each also generally represent a first stage of turbine rotor blades, a second stage of turbine rotor blades, and a third stage of turbine rotor blades, respectively.

Referring still to the embodiment of FIG. 2, the turbine section 100 additionally includes a bearing assembly 152 comprising a thrust bearing 154. The bearing assembly 152 can further include a second bearing 156 and/or a third bearing 158. In an embodiment, the bearing assembly 152 can include two or more bearings. The bearing assembly 152 can rotatably and axially support the plurality of turbine rotor blades 106 and/or 108 relative to the static structure 146 of the turbine 100, and more particularly, relative to the center frame support assembly 148 of the static structure 146. The thrust bearing 154 can transfer axial load between the second support member 134, or a portion thereof, and the static structure 146 through a load path L. The load path can extend through the gearbox 122 and transmit axial loads from the turbine 100 to the static structure 146. In certain instances, the thrust bearing 154 may further support radial loading forces exhibited between the second support member 134 and the static structure 146.

As depicted in FIG. 2, the thrust bearing 154 can be disposed in the load path L at a location upstream of the gearbox 122. In an embodiment, the thrust bearing 154 can be disposed between the second support member assembly 132and the static structure 146. In certain instances, the second support member assembly 132can define a plurality of support structures, such as two or more parallel, axially-extending support structures. By way of example, one of the two or more parallel, axially-extending support structures of the second support member assembly 132can extend between the plurality of turbine rotor blades 108 and the gearbox 122 while another of the two or more parallel, axially-extending support structures of the second support member assembly 132 can extend between the thrust bearing 154 and the second bearing 156. In an embodiment, the two or more parallel, axially-extending support structures can be connected together at a common junction located between the second bearing 156 and the plurality of turbine rotor blades 108. Force along the load path L can be transmitted from the plurality of turbine rotor blades 108 through at least one of the two or more parallel, axially-extending support structures of the second support member 134 (e.g., the second support member 134) to the gearbox 122 through the thrust bearing 154 while torque is transmitted to the gearbox 122 through the sun shaft 135. In such a manner, a connection interface formed between the plurality of turbine rotor blades 108 and the gearbox 122 can be supported with reduced axial loading conditions exhibited on the gearbox 122.

In an embodiment, the static structure 146 can define a circumferentially extending cavity 160 in which the thrust bearing 154 can be at least partially, such as fully, disposed within. The cavity 160 may extend continuously, i.e., uninterrupted, around the circumference of the turbine 100. Alternatively, the cavity 160 may include a plurality of discrete volumes spaced apart by radially open gaps. In an embodiment, the static structure 146 can include an axial surface 162 configured to receive axial loads from the thrust bearing 154 along the load path L. The axial surface 162 can extend radially along at least a portion of a radial thickness of the thrust bearing 154. The axial surface 162 can be configured to receive loading forces from the thrust bearing 154 and transfer the loading forces through the center frame support assembly 148 to the turbine center frame 142. In other embodiments, the axial loads can be supplied to the static structure 146 without the use of axial surface 162. For example, a portion of the thrust bearing can be attached or integrally formed with the static structure 146.

The thrust bearing 154 can be a rotary bearing permitting rotation while supporting axial loading conditions. Exemplary thrust bearings 154 include thrust ball bearings, thrust roller bearings, tapered roller thrust bearings, spherical roller thrust bearings, fluid bearings, magnetic bearings, and the like. In an embodiment, the thrust bearing 154 can be configured to receive a greater axial (thrust) load, L_{A}, in the axial direction A than radial load, L_{R}, in the radial direction R. By way of example, L_{A} can be at least 1.01 L_{R}, such as at least 1.1 L_{R}, such as at least 1.25 L_{R}, such as at least 1.5 L_{R}, such as at least 2.0 L_{R}, such as at least 5.0 L_{R}. While the thrust bearing 154 may be configured to provide radial bearing characteristics, in an embodiment described herein, the thrust bearing 154 is configured to primarily transmit axial loading conditions along the load path L.

Use of the thrust bearing 154 can permit transfer of axial thrust from the turbine 100 directly to the static structure 146. This can result in a stronger integration between the turbine rotor blades 108 and the gearbox 122, a reduction in part count, weight reduction, increased engine efficiency, and increased radial and/or axial space and clearance within the turbine 100. The thrust bearing 154 can further strengthen the turbine 100 while reducing wear rates of one or more components thereof.

The second and/or third bearings 156 and/or 158 may be radial bearings configured to primarily support radial loading forces within the turbine 100. By way of example, at least one of the second and third bearings 156 and 158 can be a roller bearing, a ball bearing, a tapered roller bearing, an air bearing, and the like. In some embodiments, the second and third bearings 156 and 158 can be the same type of bearing as one another, e.g., both bearings can be roller bearings. In other embodiments, the second and third bearings 156 and 158 can be different from one another, such as different types of bearing structures, or bearings having different shapes, sizes, or characteristics as compared to one another.

The second and/or third bearings 156 and/or 158 may, for example, each integrate with one or both of the first plurality of turbine rotor blades 106 and the second plurality of turbine rotor blades 108. In an embodiment, the second bearing 156 can provide a bearing interface between the second plurality of turbine rotor blades 108 and the static structure 146 while the third bearing 158 can provide a bearing interface between the first plurality of turbine rotor blades 106 and the static structure 146. Arrangements other than that depicted in FIG. 2 may occur within the spirit of the disclosure. Other exemplary embodiments are depicted in FIGS. 3 to 19.

FIGS. 3 to 10 are close-up, schematic, cross-sectional views of turbine sections having similar configurations as described with respect to the exemplary embodiment illustrated in FIG. 2. The embodiments illustrated in FIGS. 2 to 10 correspond with vaneless counter-rotating turbines (VCRT) with alternating turbine rotor blades of a first plurality of rotor blades (e.g. a high-speed turbine) and turbine rotor blades of a second plurality of rotor blades (e.g., a low-speed turbine). That is, the embodiments depicted in FIGS. 2 to 10 include a first plurality of turbine rotor blades interdigitated with a second plurality of turbine rotor blades. The first and second plurality of turbine rotor blades can counter-rotate relative to one another.

FIG. 3 shows an arrangement of a turbine 300 having similar characteristics as compared to the turbine 100 depicted in FIG. 2, with the third bearing 158 disposed in an area between, and supporting relative to one another, the first support member 128 and the rear frame support assembly 150. In this regard, the third bearing 158 is disposed at the aft of the turbine 300. The third bearing 158 can be interposed between portions of the first support member 128 and the rear frame support assembly 150. For example, in an embodiment, the third bearing 158 can be disposed on cantilevered sections of the first support member 128 and the rear frame support assembly 150. The cantilevered sections can be radially stacked and spaced apart from one another by the radial thickness of the third bearing 158. In certain instances, the entire third bearing 158 can be disposed axially between the cantilevered sections. In other instances, a portion of the third bearing 158 can extend axially beyond one or both cantilevered sections. The second bearing 156 of the embodiment illustrated in FIG. 3 is disposed between the static structure 146 and the second support member 134, similar, or the same, as depicted in FIG. 2.

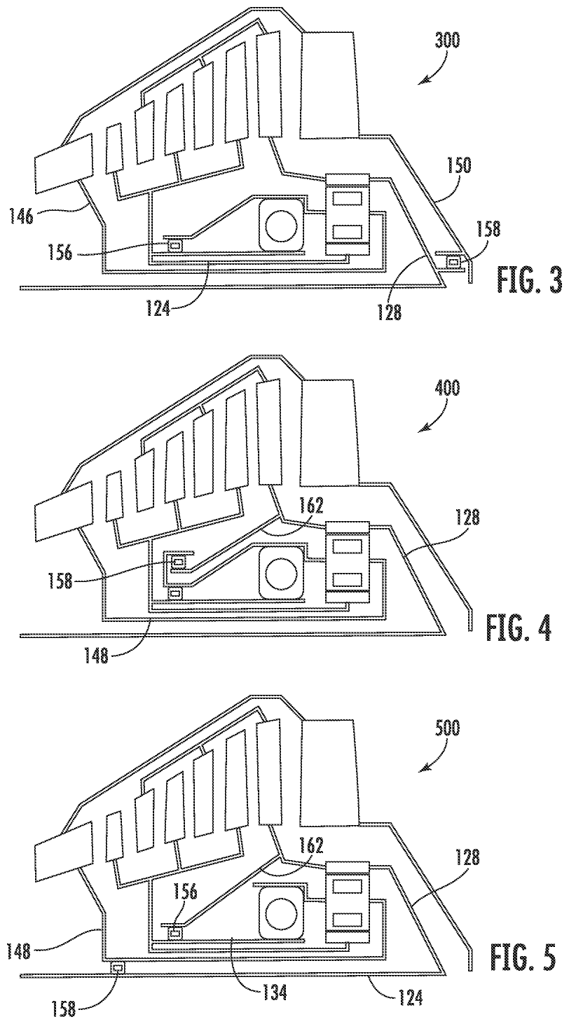

FIG. 4 shows an arrangement of a turbine 400 having similar characteristics as compared to the turbines 100 and 300 depicted in FIGS. 2 and 3, with the third bearing 158 disposed in an area between, and supporting relative to one another, the center frame support assembly 148 and an extension 162 of the first support member 128. In this regard, the third bearing 158 is disposed on a central static structure of the turbine 400.

FIG. 5 shows an arrangement of a turbine 500 having similar characteristics as compared to the turbines 100, 300, and 400 depicted in FIGS. 2, 3, and 4, with the second bearing 156 disposed between, and supporting relative to one another, the extension 162 of the first support member 128 and the second support member 134 while the third bearing 158 is disposed in an area between, and supporting relative to one another, the spool 124 and the center frame support assembly 148. As depicted in FIG. 5, the center frame support assembly 148 terminates at a location nearer to the thrust bearing 154 as compared to the turbines 100, 300, and 400.

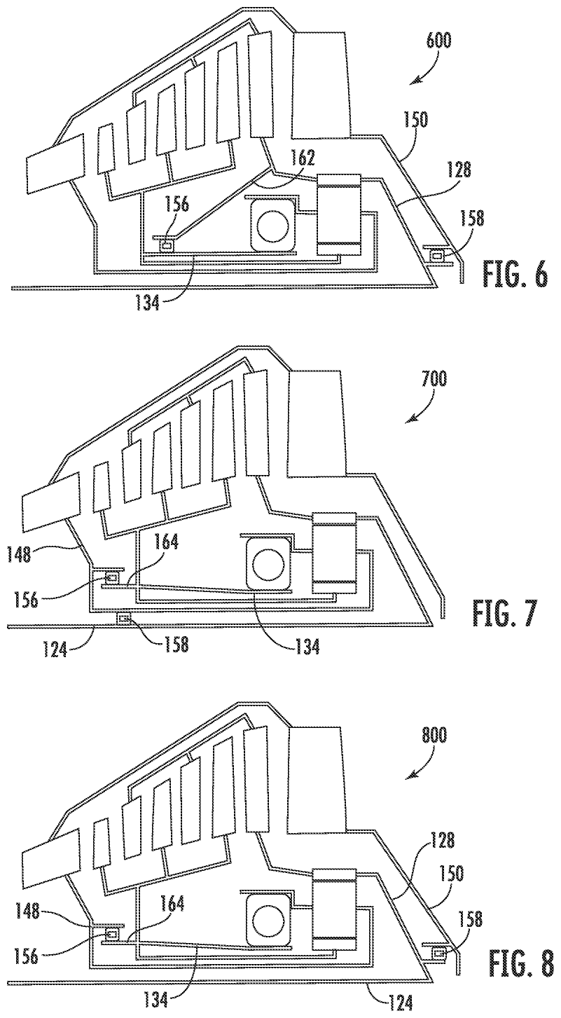

FIG. 6 shows an arrangement of a turbine 600 having similar characteristics as compared to the turbines 100, 300, 400, and 500 depicted in FIGS. 2, 3, 4, and 5, with the second bearing 156 disposed between, and supporting relative to one another, the extension 162 of the first support member 128 and the second support member 134 while the third bearing 158 disposed in an area between, and supporting relative to one another, the first support member 128 and the rear frame support assembly 150.

FIG. 7 shows an arrangement of a turbine 700 having similar characteristics as compared to the turbines 100, 300, 400, 500, and 600 depicted in FIGS. 2, 3, 4, 5, and 6, with the second bearing 156 disposed between, and supporting relative to one another, the second support member 134 and the center frame support assembly 148 at a location upstream of the second support member 134 while the third bearing 158 is disposed between, and supporting relative to one another, the center frame support assembly 148 and the spool 124. As illustrated, the second bearing 156 can contact an extension 164 of the second support member 134.

FIG. 8 shows an arrangement of a turbine 800 having similar characteristics as compared to the turbines 100, 300, 400, 500, 600, and 700 depicted in FIGS. 2, 3, 4, 5, 6, and 7, with the second bearing 156 disposed between, and supporting relative to one another, the second support member 134 and the center frame support assembly 148 at a location upstream of the second support member 134 while the third bearing 158 is disposed between, and supporting relative to one another, the first support member 128 and the rear frame support assembly 150. The second bearing 156 can contact the extension 164 of the second support member 134

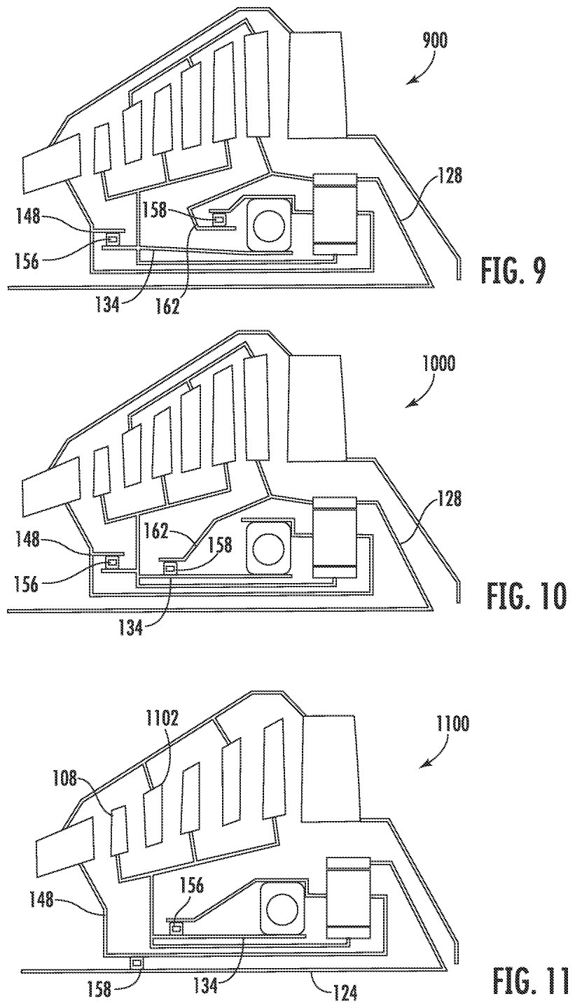

FIG. 9 shows an arrangement of a turbine 900 having similar characteristics as compared to the turbines 100, 300, 400, 500, 600, 700, and 800 depicted in FIGS. 2, 3, 4, 5, 6, 7, and 8 with the second bearing 156 disposed between, and supporting relative to one another, the second support member 134 and the center frame support assembly 148 at a location upstream of the second support member 134 while the third bearing 158 is disposed between, and supporting relative to one another, the center frame support assembly 148 and an extension 162 of the first support member 128.

FIG. 10 shows an arrangement of a turbine 1000 having similar characteristics as compared to the turbines 100, 300, 400, 500, 600, 700, 800 and 900 depicted in FIGS. 2, 3, 4, 5, 6, 7, 8, and 9 with the second bearing 156 disposed between, and supporting relative to one another, the second support member 134 and the center frame support assembly 148 at a location upstream of the second support member 134 while the third bearing 158 is disposed between, and supporting relative to one another, the first support member 128 and the second support member 134.

FIGS. 11 to 19 are close-up, schematic, cross-sectional views of single-staged, high-speed turbine sections.

FIG. 11 shows an arrangement of a turbine 1100 with turbine rotor blades 108 interspaced apart from one another by stators 1102. The stators 1102 replace turbine rotor blades 106 (FIG. 2). The turbine 1100 includes a second bearing 156 disposed between, and supporting relative to one another, the second support member 134 and the center frame support assembly 148, while the third bearing 158 is disposed between, and supporting relative to one another, the center frame support assembly 148 and the spool 124.

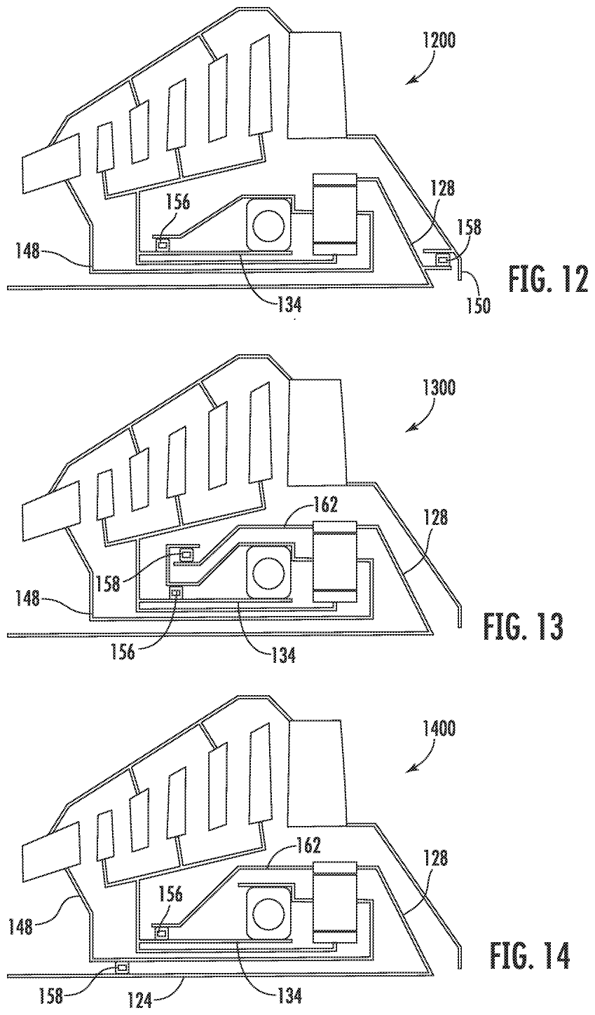

FIG. 12 shows an arrangement of a turbine 1200 having similar characteristics as compared to the turbine 1100 depicted in FIG. 11 with the second bearing 156 disposed between, and supporting relative to one another, the second support member 134 and the center frame support assembly 148, while the third bearing 158 is disposed between, and supporting relative to one another, the first support member 128 and the rear frame support assembly 150.

FIG. 13 shows an arrangement of a turbine 1300 having similar characteristics as compared to the turbines 1100 and 1200 depicted in FIGS. 11 and 12 with the second bearing 156 disposed between, and supporting relative to one another, the center frame support assembly 148 and the second support member 134, while the third bearing 158 disposed in an area between, and supporting relative to one another, the center frame support assembly 148 and an extension 162 of the first support member 128.

FIG. 14 shows an arrangement of a turbine 1400 having similar characteristics as compared to the turbines 1100, 1200, and 1300 depicted in FIGS. 11, 12, and 13 with the second bearing 156 disposed between, and supporting relative to one another, the extension 162 of the first support member 128 and the second support member 134 while the third bearing 158 is disposed in an area between, and supporting relative to one another, the spool 124 and the center frame support assembly 148.

FIG. 15 shows an arrangement of a turbine 1500 having similar characteristics as compared to the turbines 1100, 1200, 1300, and 1400 depicted in FIGS. 11, 12, 13, and 14 with the second bearing 156 disposed between, and supporting relative to one another, the extension 162 of the first support member 128 and the second support member 134 while the third bearing 158 disposed in an area between, and supporting relative to one another, the first support member 128 and the rear frame support assembly 150.

FIG. 16 shows an arrangement of a turbine 1600 having similar characteristics as compared to the turbines 1100, 1200, 1300, 1400, and 1500 depicted in FIGS. 11, 12, 13, 14, and 15 with the second bearing 156 disposed between, and supporting relative to one another, the second support member 134 and the center frame support assembly 148 at a location upstream of the second support member 134 while the third bearing 158 is disposed between, and supporting relative to one another, the center frame support assembly 148 and the spool 124.

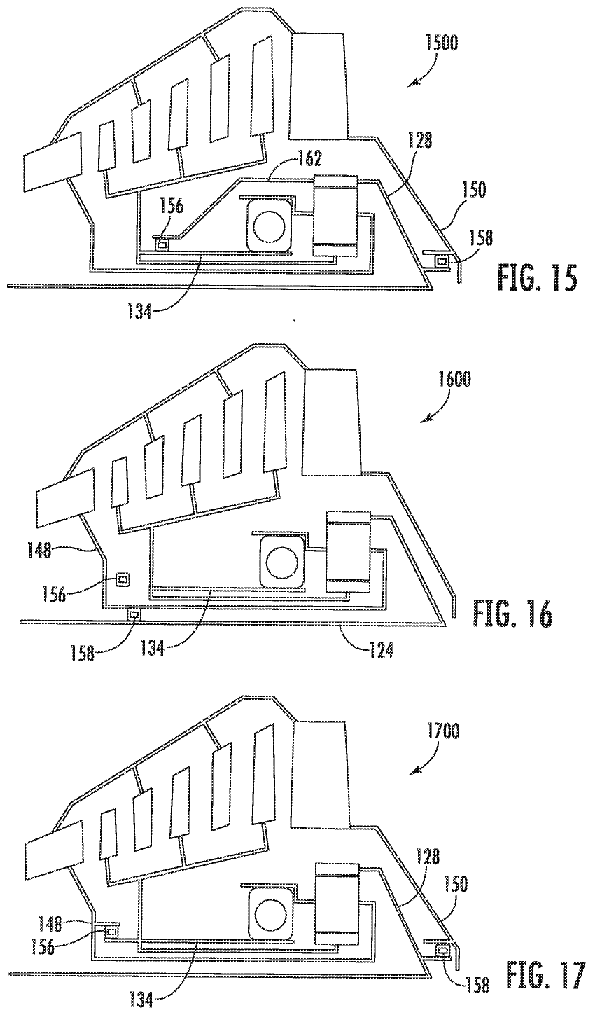

FIG. 17 shows an arrangement of a turbine 1700 having similar characteristics as compared to the turbines 1100, 1200, 1300, 1400, 1500, and 1600 depicted in FIGS. 11, 12, 13, 14, 15, and 16 with the second bearing 156 disposed between, and supporting relative to one another, the second support member 134 and the center frame support assembly 148 at a location upstream of the second support member 134 while the third bearing 158 is disposed between, and supporting relative to one another, the first support member 128 and the rear frame support assembly 150.

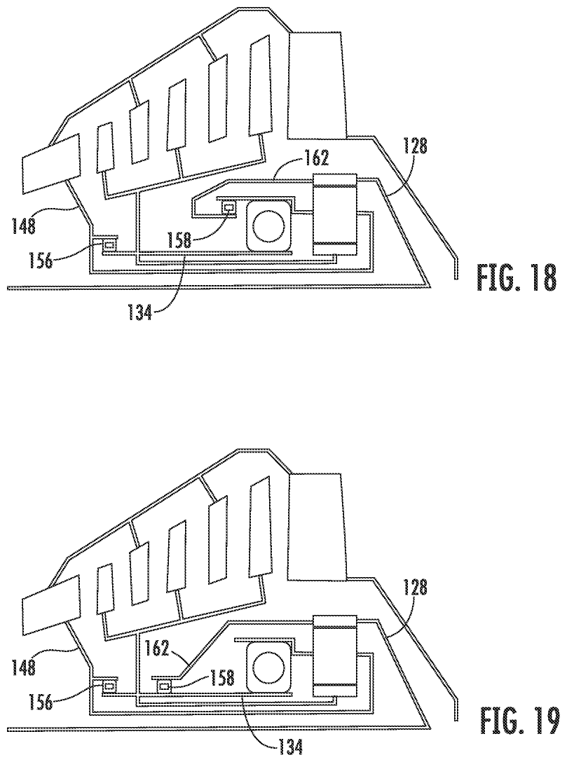

FIG. 18 shows an arrangement of a turbine 1800 having similar characteristics as compared to the turbines 1100, 1200, 1300, 1400, 1500, 1600, and 1700 depicted in FIGS. 11, 12, 13, 14, 15, 16, and 17 with the second bearing 156 disposed between, and supporting relative to one another, the second support member 134 and the center frame support assembly 148 at a location upstream of the second support member 134 while the third bearing 158 is disposed between, and supporting relative to one another, the center frame support assembly 148 and an extension 162 of the first support member 128.

FIG. 19 shows an arrangement of a turbine 1900 having similar characteristics as compared to the turbines 1100, 1200, 1300, 1400, 1500, 1600, 1700, and 1800 depicted in FIGS. 11, 12, 13, 14, 15, 16, 17, and 18 with the second bearing 156 disposed between, and supporting relative to one another, the second support member 134 and the center frame support assembly 148 at a location upstream of the second support member 134 while the third bearing 158 is disposed between, and supporting relative to one another, the second support member 134 and an extension 162 of the first support member 128.

It should further be appreciated that in other exemplary embodiments the turbine may have still any other suitable configuration. For example, in other exemplary embodiments, the turbine may have any other suitable configuration of bearings, any other suitable location of the gearbox 122, may include any other suitable configuration for the first plurality of turbine rotor blades 106, and further may have any other suitable configuration for the second plurality of turbine rotor blades 108. Further, in other exemplary embodiments, although for the embodiment depicted the first and second pluralities of turbine rotor blades 106, 108 each includes three turbine rotor blades, in other exemplary embodiments, one or both of the first and second pluralities of turbine rotor blades 106, 108 may include any other suitable number of stages of turbine rotor blades, such as two, four, etc. Moreover, in other exemplary embodiments, the turbine section and turbine may not include each of the components described above with reference to, and depicted in, FIG. 2, and further may include any other suitable components not described above with reference to, or depicted in, FIG. 2.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

A turbomachine defining a radial direction and an axial direction, the turbomachine comprising: a structural assembly comprising a frame and a static structure; a gearbox coupled to the structural assembly through the static structure; a turbine coupled to the gearbox and having a plurality of turbine rotor blades spaced apart from one another in the axial direction, each of the turbine rotor blades extending in the radial direction; and a thrust bearing disposed in a load path from the turbine to the static structure, the load path extending through the gearbox to transmit axial loads from the turbine to the static structure.

The turbomachine of one or more of these clauses, wherein the thrust bearing is disposed in the load path at a location upstream of the gearbox.

The turbomachine of one or more of these clauses, wherein the static structure defines a circumferentially extending cavity, and wherein at least a portion of the thrust bearing is disposed within the cavity.

The turbomachine of one or more of these clauses, wherein the turbine comprises a turbine support extending to the gearbox, wherein the static structure comprises a first portion located forward of the gearbox and a second portion located aft of the gearbox, wherein the thrust bearing is positioned between the first portion of the static structure and the turbine support, and wherein the second portion of the static structure extends from the gearbox to the static structure.

The turbomachine of one or more of these clauses, wherein the turbine comprises a first plurality of turbine rotor blades and a second plurality of turbine rotor blades at least partially interdigitated with the first plurality of turbine rotor blades.

The turbomachine of one or more of these clauses, wherein the turbine further comprises a first turbine support rotatable with the first plurality of turbine rotor blades and a second turbine support rotatable with the second plurality of turbine rotor blades, wherein the gearbox comprises a planetary gear set including a ring gear coupled to the first plurality of turbine rotor blades through the first turbine support, two or more planetary gears coupled to the static structure, and a sun gear coupled to the second plurality of turbine rotor blades through the second turbine support.

The turbomachine of one or more of these clauses, wherein at least a portion of the thrust bearing is disposed radially between the static structure and the first turbine support of the turbine.

The turbomachine of one or more of these clauses, further comprising a first radial bearing disposed at least partially between the static structure and a drum of a high-speed turbine or a drum of a low-speed turbine.

The turbomachine of one or more of these clauses, wherein the frame is a turbine center frame, and wherein the static structure is cantilever mounted on the turbine center frame of the turbomachine and extends radially inward toward a central axis of the turbomachine.

The turbomachine of one or more of these clauses, wherein the static structure defines an axial surface configured to receive axial loads from the thrust bearing.

A turbine section for a turbomachine defining an axial direction and a radial direction, the turbine section comprising: a gearbox; a turbine coupled to the gearbox and having a plurality of turbine rotor blades spaced apart from one another in the axial direction, each of the turbine rotor blades extending in the radial direction; and a thrust bearing configured to be disposed in a load path from the turbine to a static structure of the turbomachine, the load path extending through the gearbox to transmit axial loads from the turbine to the static structure.

The turbine section of one or more of these clauses, wherein the thrust bearing is disposed in the load path at a location upstream of the gearbox.

The turbine section of one or more of these clauses, wherein the turbine section comprises a first plurality of turbine rotor blades and a second plurality of turbine rotor blades at least partially interdigitated with the first plurality of turbine rotor blades.

The turbine section of one or more of these clauses, wherein the turbine further comprises a first turbine support rotatable with the first plurality of turbine rotor blades and a second turbine support rotatable with the second plurality of turbine rotor blades, wherein the gearbox comprises a planetary gear set including a ring gear coupled to the first plurality of turbine rotor blades through the first turbine support, two or more planetary gears configured to be coupled to static structure, and a sun gear coupled to the second plurality of turbine rotor blades through a second turbine support.

The turbine section of one or more of these clauses, further comprising a first radial bearing disposed at least partially between the static structure and the turbine.

The turbine section of one or more of these clauses, wherein the thrust bearing is configured to transmit force to the static structure through an axial surface of the static structure.

A vaneless counter-rotating turbine (VCRT) turbomachine defining a radial direction and an axial direction, the turbomachine comprising: a gearbox coupled to a static structure of the turbomachine; a turbine coupled to the gearbox, the turbine comprising: a low-speed turbine including a first plurality of turbine rotor blades spaced apart from one another in the axial direction and extending radially from a rotatable drum; and a high-speed turbine including a second plurality of turbine rotor blades spaced apart from one another in the axial direction and extending radially from a rotatable drum, wherein each turbine rotor blade of the second plurality of turbine rotor blades is spaced apart in the axial direction by at least one turbine rotor blade of the first plurality or turbine rotor blades; and a thrust bearing disposed between the static structure and the drum of the high-speed turbine, the thrust bearing being configured to transmit axial loads from the high-speed turbine to the static structure.

The VCRT turbomachine of one or more of these clauses, wherein the low-speed turbine is rotating in a first circumferential direction and the high-speed turbine is rotating in a second circumferential direction opposite the first circumferential direction.

The VCRT turbomachine of one or more of these clauses, further comprising a first radial bearing disposed between the drum of the high-speed turbine and the static structure, the first radial bearing being spaced apart from the thrust bearing in the axial direction.

The VCRT turbomachine of one or more of these clauses, wherein the gearbox comprises a planetary gear set including a sun gear coupled to the drum of the high-speed turbine, two or more planetary gears coupled to the static structure, and a ring gear coupled to the drum of the low-speed turbine.

What is claimed is:

1. A turbomachine defining a radial direction and an axial direction, the turbomachine comprising:
a structural assembly comprising a frame and a static structure;
a gearbox coupled to the structural assembly through the static structure;
a turbine coupled to the gearbox and having a plurality of turbine rotor blades spaced apart from one another in the axial direction, each of the turbine rotor blades extending in the radial direction; and
a thrust bearing disposed in a load path from the turbine to the static structure, the load path extending through the gearbox to transmit axial loads from the turbine to the static structure.

2. The turbomachine of claim 1, wherein the thrust bearing is disposed in the load path at a location upstream of the gearbox.

3. The turbomachine of claim 1, wherein the static structure defines a circumferentially extending cavity, and wherein at least a portion of the thrust bearing is disposed within the cavity.

4. The turbomachine of claim 1, wherein the turbine comprises a turbine support extending to the gearbox, wherein the static structure comprises a first portion located forward of the gearbox and a second portion located aft of the gearbox, wherein the thrust bearing is positioned between the first portion of the static structure and the turbine support, and wherein the second portion of the static structure extends from the gearbox to the static structure.

5. The turbomachine of claim 1, wherein the turbine comprises a first plurality of turbine rotor blades and a second plurality of turbine rotor blades at least partially interdigitated with the first plurality of turbine rotor blades.

6. The turbomachine of claim 4, wherein the turbine further comprises a first turbine support rotatable with the first plurality of turbine rotor blades and a second turbine support rotatable with the second plurality of turbine rotor blades, wherein the gearbox comprises a planetary gear set including a ring gear coupled to the first plurality of turbine rotor blades through the first turbine support, two or more planetary gears coupled to the static structure, and a sun gear coupled to the second plurality of turbine rotor blades through the second turbine support.

7. The turbomachine of claim 5, wherein at least a portion of the thrust bearing is disposed radially between the static structure and the first turbine support of the turbine.

8. The turbomachine of claim 1, further comprising a first radial bearing disposed at least partially between the static structure and a drum of a high-speed turbine or a drum of a low-speed turbine.

9. The turbomachine of claim 1, wherein the frame is a turbine center frame, and wherein the static structure is cantilever mounted on the turbine center frame of the turbomachine and extends radially inward toward a central axis of the turbomachine.

10. The turbomachine of claim 1, wherein the static structure defines an axial surface configured to receive axial loads from the thrust bearing.

11. A turbine section for a turbomachine defining an axial direction and a radial direction, the turbine section comprising:
a gearbox;
a turbine coupled to the gearbox and having a plurality of turbine rotor blades spaced apart from one another in the axial direction, each of the turbine rotor blades extending in the radial direction; and
a thrust bearing configured to be disposed in a load path from the turbine to a static structure of the turbomachine, the load path extending through the gearbox to transmit axial loads from the turbine to the static structure.

12. The turbine section of claim 11, wherein the thrust bearing is disposed in the load path at a location upstream of the gearbox.

13. The turbine section of claim 11, wherein the turbine section comprises a first plurality of turbine rotor blades and a second plurality of turbine rotor blades at least partially interdigitated with the first plurality of turbine rotor blades.

14. The turbine section of claim 13, wherein the turbine further comprises a first turbine support rotatable with the first plurality of turbine rotor blades and a second turbine support rotatable with the second plurality of turbine rotor blades, wherein the gearbox comprises a planetary gear set including a ring gear coupled to the first plurality of turbine rotor blades through the first turbine support, two or more planetary gears configured to be coupled to static structure, and a sun gear coupled to the second plurality of turbine rotor blades through a second turbine support.

15. The turbine section of claim 11, further comprising a first radial bearing disposed at least partially between the static structure and the turbine.

16. The turbine section of claim 11, wherein the thrust bearing is configured to transmit force to the static structure through an axial surface of the static structure.

17. A vaneless counter-rotating turbine (VCRT) turbomachine defining a radial direction and an axial direction, the turbomachine comprising:
a gearbox coupled to a static structure of the turbomachine;
a turbine coupled to the gearbox, the turbine comprising:
a low-speed turbine including a first plurality of turbine rotor blades spaced apart from one another in the axial direction and extending radially from a rotatable drum; and
a high-speed turbine including a second plurality of turbine rotor blades spaced apart from one another in the axial direction and extending radially from a rotatable drum, wherein each turbine rotor blade of the second plurality of turbine rotor blades is spaced apart in the axial direction by at least one turbine rotor blade of the first plurality or turbine rotor blades; and
a thrust bearing disposed between the static structure and the drum of the high-speed turbine, the thrust bearing being configured to transmit axial loads from the high-speed turbine to the static structure.

18. The VCRT turbomachine of claim 17, wherein the low-speed turbine is rotating in a first circumferential direction and the high-speed turbine is rotating in a second circumferential direction opposite the first circumferential direction.

19. The VCRT turbomachine of claim 17, further comprising a first radial bearing disposed between the drum of the high-speed turbine and the static structure, the first radial bearing being spaced apart from the thrust bearing in the axial direction.

20. The VCRT turbomachine of claim 17, wherein the gearbox comprises a planetary gear set including a sun gear coupled to the drum of the high-speed turbine, two or more planetary gears coupled to the static structure, and a ring gear coupled to the drum of the low-speed turbine.
